(19) United States
(12) Patent Application Publication
(10) Pub. No.: US 2008/0232792 A1
(43) Pub. Date: Sep. 25, 2008

(54) Miniaturised Support For Photographic Equipment Such as Video and Photographic Cameras

(75) Inventors: Paolo Speggiorin, Mussolente (VI) (IT); Francesco Bernardi, Romano D'Ezzelino (IT)

Correspondence Address: RATNERPRESTIA, P O BOX 980, VALLEY FORGE, PA, 19482-0980, US

(73) Assignee: LINO MANFROTTO + CO. S.P.A., Bassano Del Grappa (VI) (IT)

(21) Appl. No.: 11/914,609

(22) PCT Filed: May 5, 2006
(86) PCT No.: PCT/IT2006/000321

§ 371 Date: May 19, 2008

(30) Foreign Application Priority Data
May 17, 2005 (IT) PD2005A000137

(51) Int. Cl. G03B 17/00

(52) U.S. Cl. 396/428

(57) ABSTRACT

A miniaturised support for photographic equipment such as video and photographic cameras comprising a plate-like member capable of being fixed to, or integrated in, the equipment to be supported, and at least two flaps mounted on the plate-like member along opposite sides of same and movable between a closed position, in which both the flaps are folded behind the plate-like member, and an open position, in which the flaps are spread apart from each other as support for the plate-like member.

### TECHNICAL FIELD

The subject of the invention is a miniaturised support for photographic equipment such as video cameras and photographic cameras having the characteristics mentioned in the preamble of the main claim.

### STATE OF THE ART

In the amateur field it sometimes happens that, at the moment of having to take video/photographic shots, one realizes that there is no suitable support available, such as a tripod or the like. In this case the only practical solution is that of resting the shooting equipment on a surface found on the spot. In that event the user normally leaves the equipment resting on the surface, frames the subject to be photographed and starts the shooting equipment or presses the shutter release.

However, it happens that, with the photographic camera resting on a surface, the sighting thereof for correct framing of the subject to be taken may be extremely difficult. For example, it may happen that the supporting conditions involve interference between the user's face and the surface, or that the surface has irregularities or roughness, or is dirty, or is not flat enough to guarantee appropriate and stable supporting of the photographic camera. Last but not least, it may be the case that such use results in a part of the supporting surface also appearing in the frame.

In all these conditions it is complex both to position the equipment for the photograph and to usefully frame the subject. The present invention finds specific application in such conditions. The current prior art proposes miniaturised tripods, of the dimensions of a large pencil, which can be fitted to the video/photographic equipment when needed. Such tripods must however be fitted and then removed from the equipment, not being designed for fitting for an indefinite time. Consequently, these miniaturised tripods may be forgotten, just like tripods of larger dimensions, and not be available when needed.

### DESCRIPTION OF THE INVENTION

The technical problem underlying the invention is that of providing a miniaturised support structurally and functionally designed to make it possible to remedy the drawbacks mentioned with reference to the prior art cited. In particular, it is proposed herein to produce a support so compact as to be able to be mounted or integrated on a photographic camera or video camera in order to provide a stable support for same with a reasonable elevation above the supporting surface.

Within the framework of this problem, an important aim of the invention is that of providing a miniaturised support which can be left mounted in a stable manner on the equipment without interfering with other uses.

One other aim of the invention is that of rendering such a support advantageously adjustable.

This problem is solved and these aims are achieved by a miniaturised support produced according to the following claims.

### BRIEF DESCRIPTION OF THE DRAWINGS

The characteristics and advantages of the invention will become clearer from the following detailed description of a preferred, but not exclusive, exemplary embodiment thereof, illustrated by way of non-limiting example with reference to the appended drawings, in which:

FIG. 1 is a perspective view of a miniaturised support according to the invention in the open position;

FIG. 2 is a diagrammatic view of the support of FIG. 1 shown respectively by dashed lines and solid lines in two deployment positions;

FIG. 3 is a perspective view from below of a photographic camera provided with the support of the preceding figures in the closed position;

FIGS. 4 and 5 are diagrammatic elevational views of a further example of application of the support of the present invention.

### PREFERRED WAY OF IMPLEMENTING THE INVENTION

In the drawings, the reference 1 indicates a photographic camera including a lens 2 with shooting axis R and with a threaded blind hole 3 provided in a base 4 thereof for mounting the photographic camera on tripods and similar supports.

A miniaturised support indicated as a whole by 10 is removably fixed to the base 4 by means of a screw 11 which engages in the hole 3.

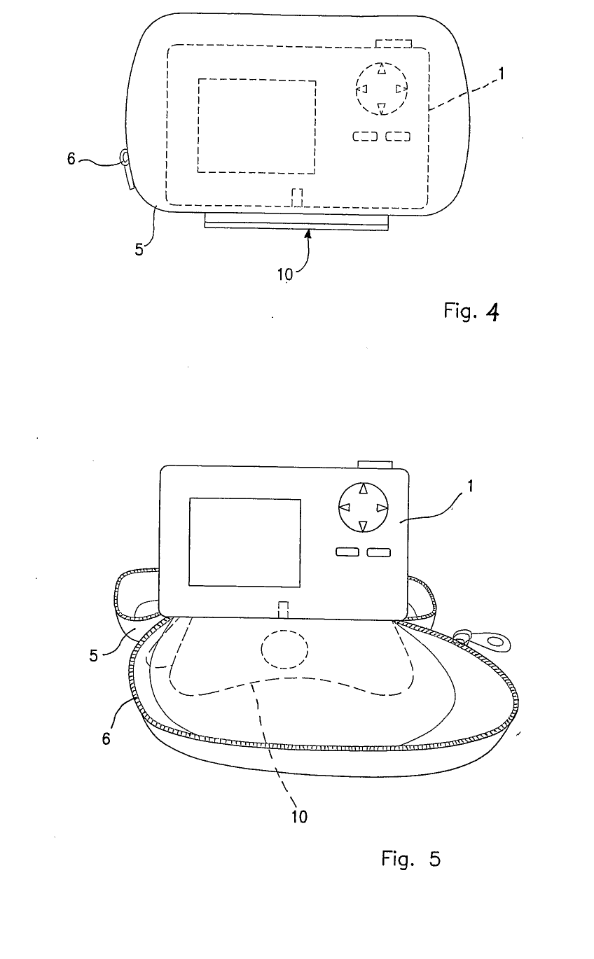

The support 10 comprises a plate-like member 12 of substantially rectangular configuration which can be removably fixed, as indicated, to the base 4 or integrated in a stable manner therewith, for example by providing for the plate-like member to be part of the base 4. With reference to the example of FIGS. 4 and 4, between the plate-like member 12 and the base 4 a flexible edge of a case 5 is interposed, provided with a closure 6 with which it can be closed to protect the photographic camera 1. The support 10 may also be joined to the case 5 in such a way as to render it an integral part thereof, for example by fitting the plate-like member 12 to the case in a stable manner.

The plate-like member 12 has two opposed major sides along which is hinged, with a capacity for pivoting about a respective axis X1 and X2, a corresponding flap 13, also of generally rectangular configuration, with the side opposed to the respective axis X1, X2 configured so as to form two opposed feet 14a, 14b.

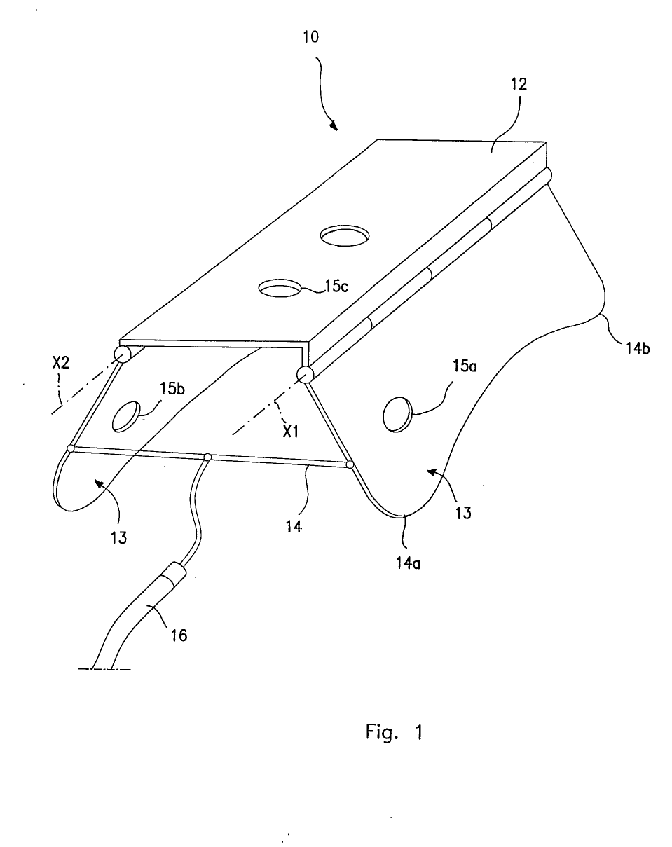

The flaps 13 are movable between a closed position, in which they are both folded close to the plate-like member 12 (FIG. 3), and an open position (FIG. 1), in which they are spread apart from each other as support for the plate-like member and the photographic camera 1 mounted thereon.

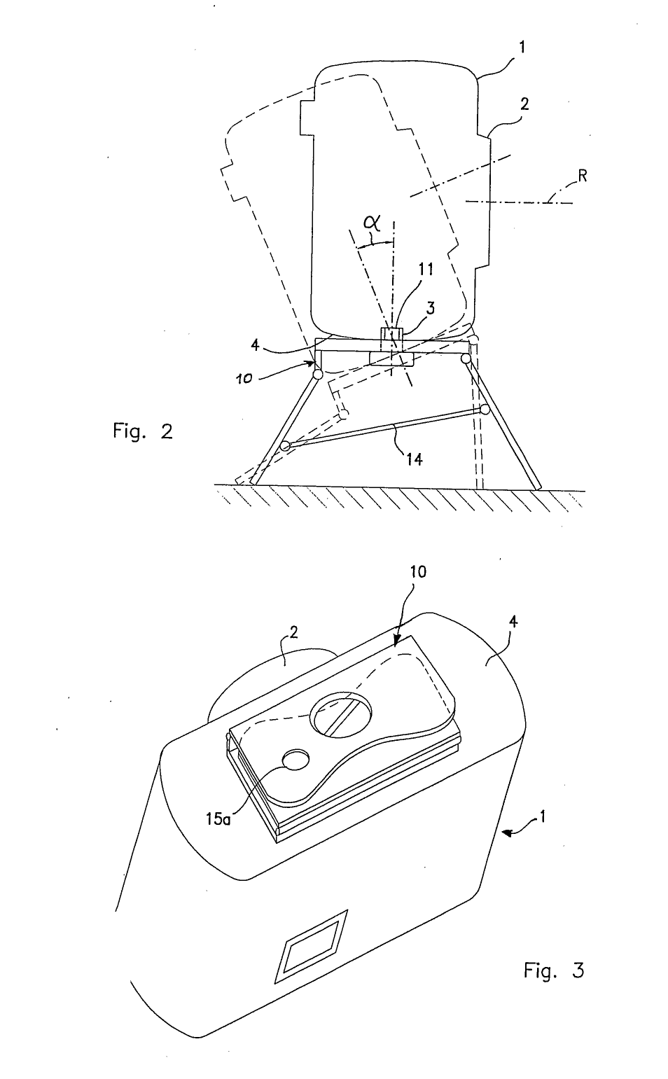

According to a first embodiment of the invention, between the flaps and the plate-like member, stops are provided, such as abutment surfaces between the hinging region of the flaps 13 and the plate-like member 12, and which determine a relative, fixed, angular positioning thereof, in the open state. However, it is preferable for the angular position of orientation of the flaps with respect to the plate-like member to be adjustable, as illustrated in the example of FIGS. 1 and 2. For this purpose, the flaps are free to pivot at will about the axis X1, X2 of articulation on the plate-like member 12 but are linked to each other by a tie-rod 14 secured to each of them in a position spaced from the respective hinging axis. In this way, the angles formed by the flaps with respect to the plate-like member are adjustable and their sum is substantially constant or variable according to a predetermined law, generally linear. Alternatively, provision is further made for the pivoting of the flaps with respect to the plate-like member to be frictioned.

The tie-rod 14 is flexible, for example is constituted by a small cable and in turn constitutes a coupling means for a carrying strap 16.

Advantageously, the flaps 13 and the plate-like member 12 have a respective hole 15a,b,c, at least partly threaded, corresponding in diameter and thread to the hole 3 in the base 4 in order to allow the fixing of the photographic camera 1, with the support 10 mounted and the flaps 13 folded into the closed position, on a tripod with standard attachment means, without requiring the prior removal of the support 10.

Among the principal advantages of the tripod of the present invention is the significant compactness, which renders it permanently available on the photographic camera without any hindrance to the normal use thereof, its low cost, the ease with which it can be integrated with other components, for example the photographic camera itself or its case, the ease of adjustment of the positioning and the efficacy of a modest but decisive raising of the photographic camera from the supporting surface.

1. A miniaturised support for photographic equipment such as video and photographic cameras, comprising a plate-like member capable of being fixed to, or integrated in, the equipment to be supported, and at least two flaps mounted on said plate-like member along opposite sides of same and movable between a closed position, in which both said flaps are folded close to said plate-like member, and an open position, in which said flaps are spread apart from each other as support for said plate-like member.

2. A support according to claim 1, wherein said flaps, in the open position, form an adjustable angle of opening with respect to the plate-like member.

3. A support according to claim 2, wherein said flaps are hinged, by a respective longitudinal edge thereof, along opposite sides of the plate-like member and are connected to each other by a tie-rod secured in a position spaced from the respective hinging axes, in such a way that the angles formed by the flaps with respect to the plate-like member are adjustable and their sum is constant or variable according to a predetermined law.

4. A support according to claim 3, wherein said tie-rod is flexible.

5. A support according to claim 3, wherein said tie-rod constitutes a coupling means for a carrying strap.

6. A support according to claim 1, wherein, on said plate-like member and/or on said flaps, an attachment means for standard tripods is provided in order to secure the equipment to a tripod without removing said support.

7. A support according to claim 6, wherein said attachment means comprises a threaded hole on the plate-like member and/or on at least one of the flaps, said hole being accessible when said flaps are in the closed position.

8. A support according to claim 1 including a case for said equipment integrated with said support and/or firmly connected thereto.
